(19) United States
(12) Patent Application Publication
(10) Pub. No.: US 2026/0204793 A1
(43) Pub. Date: Jul. 16, 2026

(54) Frequency Selective Filter, Antenna, Mobile Communication Base Station as Well as User Device

(71) Applicant: Telefonaktiebolaget LM Ericsson (publ), Stockholm (SE)

(72) Inventors: Marko Sonkki, Rosenheim (DE); Meenakshy lyer, Plano, TX (US); Robert Bieber, Rosenheim (DE); Desong Wang, Ottawa (CA); Michael Ponschab, Rosenheim (DE)

(21) Appl. No.: 19/134,938

(22) PCT Filed: Dec. 1, 2023
(86) PCT No.: PCT/EP2023/083974

§ 371 Date: Jun. 2, 2025

(30) Foreign Application Priority Data
Feb. 12, 2022 (WO) PCT/EP2022/084277

(51) Int. Cl. H01Q 15/00; H01Q 1/52

(52) U.S. Cl. CPC H01Q 15/0013; H01Q 1/52

(57) ABSTRACT

A frequency selective filter (18) for electromagnetic waves has a substrate (24) and a conductive structure (26) provided at the substrate (24), the conductive structure (26) having a plurality of filter elements (28) and a plurality of capacitive elements (30). The plurality of filter elements (28) forms an array of filter elements (28) forming a first resonance structure (32) for a first frequency band. The capacitive elements (30) of the plurality of capacitive elements (30) encircle one of or a group (44) of the plurality of filter elements (28) comprised in the array of filter elements (28), wherein the plurality of capacitive elements (30) forms a second resonance structure for a second frequency band, having a different filtering characteristic as the first resonance structure. The array of filter elements (28) spans a filter plane, at least one capacitive element extending in the filter plane. Further, an antenna (14; 16), a mobile communication base station (10) and a user device (12) are shown.

### TECHNICAL FIELD

The invention relates to a frequency selective filter, an antenna, a mobile communication base station as well as a user device.

### BACKGROUND

In multiband antennas, radiators or arrays of radiators for at least two different frequency bands are arranged close to one another. It is known to arrange the radiators of different frequency bands one behind the other in the radiation direction of the antenna, wherein the radiators for the higher frequency band are arranged behind the radiators for the lower frequency band.

In order to isolate the radiators of different frequency bands from one another, it is known to use frequency selective filters that are arranged between the radiators of different frequency bands. Such frequency selective filters have different filtering characteristics in different frequency bands.

For example, “Terahertz dual-band nearly perfect absorbers based on combined of two types of FSS elements”, Authors: Jianhua Wu, Weiping Qin, IEEE MTT-S International Microwave Workshop Series on Millimeter Wave Wireless Technology and Applications, 2012, suggests a combination of different geometries of filter elements to achieve filter characteristics in different frequency bands.

Further, CN 108 682 963 A suggests arranging different filter elements in different filter planes to obtain the desired characteristics.

US 2019/0131713 A1 shows a frequency selective surface having an array of filter elements and a cross-shaped metal patch dividing the array of filter elements into four parts.

CN 103 943 967 A, U.S. Pat. No. 8,816,921 B2, US 2014/118217 A1, U.S. Pat. No. 10,601,141 B2 and ZARGAR MEHRAN MANZOOR ET AL: “Single-Layered Flexible Dual Transmissive Rasorbers With Dual/Triple Absorption Bands for Conformal Applications”, IEEE ACCESS, IEEE, USA, vol. 9, 8 Nov. 2021(2021 Nov. 8), pages 150426-150442, XP011887848 disclose frequency selective filters having a first conductive element at least partly encircled by a second conductive element.

However, these approaches yield only unsatisfactory results, as only the same filter characteristics (e.g. band-stop, band-pass, high-pass, or the like) may be achieved or the structure of the filter itself becomes complex.

### SUMMARY

It is therefore an object of the invention to provide a frequency selective filter with resonance structures in different frequency bands having a simple construction.

For this purpose, a frequency selective filter for electromagnetic waves is provided, comprising a substrate and a conductive structure provided at the substrate. The conductive structure comprises a plurality of filter elements and a plurality of capacitive elements, wherein the plurality of filter elements forms an array of filter elements forming a first resonance structure for a first frequency band. The capacitive elements of the plurality of capacitive elements encircle one of or a group of the plurality of filter elements comprised in the array of filter elements, wherein the plurality of capacitive elements forms a second resonance structure for a second frequency band, having a different filtering characteristic as the first resonance structure. The array of filter elements spans a filter plane, and at least one capacitive element extends in the filter plane.

In general, Frequency Selective Surfaces (FSS) can be considered as combination of filtering components, which can be parallel or series to create wanted filtering characteristics. Depending on filtering features, an FSS behaves like a series or parallel RLC circuit; The FSS patches will produce R (Resistance) and L (Inductance), and the gaps between the FSS cause C (Capacitance). Within this disclosure, a combination of these filtering components are referred to as filters, i.e. frequency selective filters.

It has been found that by encircling one of or a group of filter elements by a capacitive element, a first resonance structure of filter elements and a second resonance structure of capacitive elements with different filter characteristics can be provided in a single filter plane, which simplifies construction and manufacture of the frequency selective filter.

The substrate may be any kind of carrier for the conductive structure, like a PCB-board, a foil or a radome. In particular, the substrate is made of a dielectric material.

For example, the at least one capacitive element extends fully in the filter plane. The capacitive element may encircle the one of or the group of the plurality of filter elements in the filter plane.

In particular, each of the capacitive elements of the plurality of capacitive elements encircle one of or a group of the plurality of filter elements comprised in the array of filter elements.

Multiple of such filter planes may be provided on the substrate, e.g. on the front and back surface or as multiple layers of a multilayered PCB or on several dielectric sheets.

Within this disclosure, the term “filter plane” is to be understood as the plane comprising the filter elements.

In an embodiment, the first resonance structure for the first frequency band is a band-pass or high-pass filter for electromagnetic waves in the first frequency band, allowing the electromagnetic waves of the one or array of first radiators to pass through the filter with little losses.

The filter elements may be regarded as unit cells of the frequency selective filter.

The first frequency band lies, in particular, fully above 1.0 GHz, in particular fully above 1.4 GHz. For example, the first frequency band is 3.3 GHz to 4.2 GHz.

In particular, the second frequency band lies partly, in particular fully below the first frequency band.

For further simplifying construction, each of the filter elements may comprise at least one conductive portion, in particular a metallization, applied to the substrate, in particular wherein the at least one conductive portion has a geometry being a line; a dipole; a tripole; a cross, in particular a Jerusalem cross; a square spiral; a loop, in particular a circular loop, a squared loop, a hexagonal loop, an octagonal loop, or a loop of arbitrary shape; a patch, in particular a circular patch, a squared patch, a hexagonal patch, an octagonal patch or a patch of arbitrary shape; a combination thereof and/or a complement thereof.

In an aspect, the at least one capacitive element comprises a first conductive portion and a second conductive portion spaced apart from the first conductive portion by a gap, in particular the first conductive portion and the second conductive portion are galvanically separate from one another. This way, a capacitance in form of a gap is realized in a simple fashion.

For example, first and second conductive portions are metallizations applied to the substrate.

In order to tune the second frequency band, the at least one capacitive element may comprise a tuning device galvanically connected between the first conductive portion and the second conductive portion.

The tuning device is, for example, a varactor or mems switch.

For example, the gap has a width being at most 0.2 mm, in particular at most 0.05 mm and/or an electric width being at most 1/100, in particular at most 1/1500, more particularly at most 1/8000 of a wavelength of an average frequency of the second frequency band, providing excellent filtering characteristics.

For example, a unit cell or one filter element has a size of about one half or one quarter of a wavelength of an average frequency of the first frequency band.

The first conductive portion and/or the second conductive portion of the capacitive element may also be separate from the filter elements, in particular galvanically separate.

In an embodiment the first conductive portion, the second conductive portion and the gap have a meander section in which the first conductive portion, the second conductive portion and the gap extend in at least one meander. By providing the meander sections, the resonance stability of the second resonance structure (i.e. in the second frequency band) is improved. Further, the size of the unit cells may be reduced.

In an aspect, one of the plurality of filter elements or one of the groups of the plurality of filter elements comprises a protrusion extending into an area defined by the adjacent first or second conductive portion, in particular defined by one of the at least one meander of the meander section, leading to an improved coupling of the capacitive element to the adjacent filter element, further improving the filter quality.

In an aspect, the at least one capacitive element forms a closed trace, in particular a loop, around the one of or the group of the plurality of filter elements, providing further improved filter qualities.

In particular, the gap forms a closed trace, particularly a loop, around the one of or the group of the plurality of filter elements.

In an embodiment, the one filter element and/or the group of the plurality of filter elements has a first contour, in particular being the contour of the conductive portion, wherein the at least one capacitive element extends along the first contour. Following the contour of the filter elements leads to a very good usage of the available space.

In particular, the gap has the same contour as the first contour.

The gap may extend along the first contour, in particular following the contour directly, in meanders, in waves or in an arbitrary fashion.

For example, the entire conductive structure is provided on a single surface or a single layer of the substrate leading to a compact design.

In an embodiment, the conductive structure comprises a first array of filter elements and a second array of filter elements as well as first capacitive elements of the plurality of capacitive elements encircling one of or a group of the plurality of filter elements comprised in the first array of filter elements and second capacitive elements of the plurality of capacitive elements encircling one of or a group of the plurality of filter elements comprised in the second array of filter elements, wherein the first array of filter elements and the first capacitive elements are located in a first filter plane on a first surface or layer of the substrate, and the second array of filter elements and the second capacitive elements are located in a second filter plane and on a second surface or layer of the substrate. By providing a second array of filter elements in a second filter plane, the bandwidth of the first resonance structure is widened.

The first and second surface may be the front and the back surface. The first and second layers may be adjacent layers.

For further improved resonance characteristics, in a projection perpendicular to the substrate, the filter elements of the first and second array may be located at the same positions, in particular the geometric centers of the filter elements of the first array of filter elements may correspond to the geometric centers of the filter elements of the second array of filter elements.

In an aspect, the geometry of the filter elements of the first array of filter elements differs from the geometry of the filter elements of the second array of filter elements, further widening the bandwidth of the second resonance structure.

In order not to deteriorate the characteristics of the second resonance structure, in a projection perpendicular to the substrate, the first capacitive elements and the second capacitive elements may have an overlap of at least 80% of their area, in particular of at least 90%, more particularly they are identical.

In an embodiment, the second resonance structure for the second frequency band forms a band-stop for electromagnetic waves in the second frequency band, providing an excellent isolation of the first and second radiator or arrays of radiators.

In an aspect, the second frequency band lies, for example, fully below 1.5 GHZ, in particular below 1 GHz. For example, the second frequency band is 0.6 GHz to 0.96 GHz.

The second resonance structure formed by the capacitive element is in particular transparent for electromagnetic waves in first frequency band.

In an embodiment, the plurality of capacitive elements encircling adjacent ones or adjacent groups of the plurality of filter elements have a common section, reducing the complexity further.

For example, the common section is a shared portion of the gap of the plurality of capacitive elements and/or the gaps of the plurality of the capacitive elements form a grating, improving the filter quality.

In an embodiment, the at least one of the plurality of capacitive elements encircles a group of the plurality of filter elements and also encircles another capacitive element encircling one or a subgroup of the group of the plurality of filter elements. This way, the second frequency band is enlarged.

The encircling capacitive element and the encircled capacitive element are concentric to one another and/or to the array of filter elements.

In order to allow various antenna shapes, the substrate may be non-planar, wherein the filter plane refers to a state in which the substrate is spread out in a plane.

For above mentioned purpose, an antenna is further provided, the antenna having a frequency selective filter as described above.

The antenna has, for example, a first radiator or an array of first radiators designed for a first frequency band and a second radiator or an array of second radiators designed for a second frequency band, wherein the frequency selective filter is arranged between the first radiator or the array of first radiators and the second radiator or the array of second radiators, wherein the array of filter elements is transmissive for electromagnetic waves in the first frequency band and the at least one capacitive element is reflective for electromagnetic waves in the second frequency band.

The frequency selective filter improves the isolation between the radios at first and second frequency bands, i.e. the radiators at first and second frequency bands.

Further, for above mentioned purpose, a mobile communication base station is provided having at least one antenna as described above.

A mobile communication base station may also be called mobile communication cell site.

The mobile communication base station may be a network node of a telecommunication network, for example an ORAN network.

For above mentioned purpose, further a user device for mobile communication is shown, comprising a frequency selective filter as described above and/or an antenna as described above.

The features and advantages described with respect to the frequency selective filter also apply to the antenna, the mobile communication base station and/or the user device and vice versa.

### BRIEF DESCRIPTION OF THE DRAWINGS

Further features and advantages will be apparent from the following description as well as the accompanying drawings, to which reference is made. In the drawings:

FIG. 1 shows schematically a mobile communication base station according to an embodiment of the invention as well as a user device according to an embodiment of the invention, both having an antenna according to an embodiment of the invention,

FIG. 2 shows a schematic overview of one of the antennas of FIG. 1 having a frequency selective filter according to an embodiment of the invention,

FIG. 3 shows a schematic sectional view of the frequency selective filter of FIG. 2,

FIG. 4 shows a schematic top view of the frequency selective filter of FIG. 2,

FIG. 5 shows an enlarged view of part of FIG. 4,

FIGS. 6, 7 show graphs illustrating the transmission and reflection of a frequency selective filter without a second resonance structure and according to the invention, respectively,

FIG. 8 shows a schematic top view of a second embodiment of a frequency selective filter according to the invention,

FIG. 9 shows an enlarged view of the frequency selective filter of FIG. 8,

FIG. 10 shows a schematic top view of a third embodiment of a frequency selective filter according to the invention,

FIG. 11 shows a schematic top view of a fourth embodiment of a frequency selective filter according to the invention schematically,

FIG. 12a)-g) show schematically possible geometries of the conductive portions of filter elements of frequency selective filters according to the invention,

FIG. 13 shows a schematic top view of a fifth embodiment of a frequency selective filter according to the invention,

FIG. 14 shows a schematic top view of a sixth embodiment of a frequency selective filter according to the invention,

FIG. 15 shows an enlarged view of an intersection of the frequency selective filter of FIG. 14,

FIG. 16 shows a schematic top view of a filter element of a seventh embodiment of a frequency selective filter according to the invention,

FIG. 17 shows a schematic top view of another filter element of the seventh embodiment of a frequency selective filter according to the invention,

FIG. 18 illustrates a projection of the conductive structure perpendicular to the surface or layer of the frequency selective filter according to FIGS. 16 and 17,

FIG. 19 shows a schematic top view of a filter element of an eighth embodiment of a frequency selective filter according to the invention, and

FIG. 20 shows a schematic top view of a filter element of a ninth embodiment of a frequency selective filter according to the invention.

### DETAILED DESCRIPTION

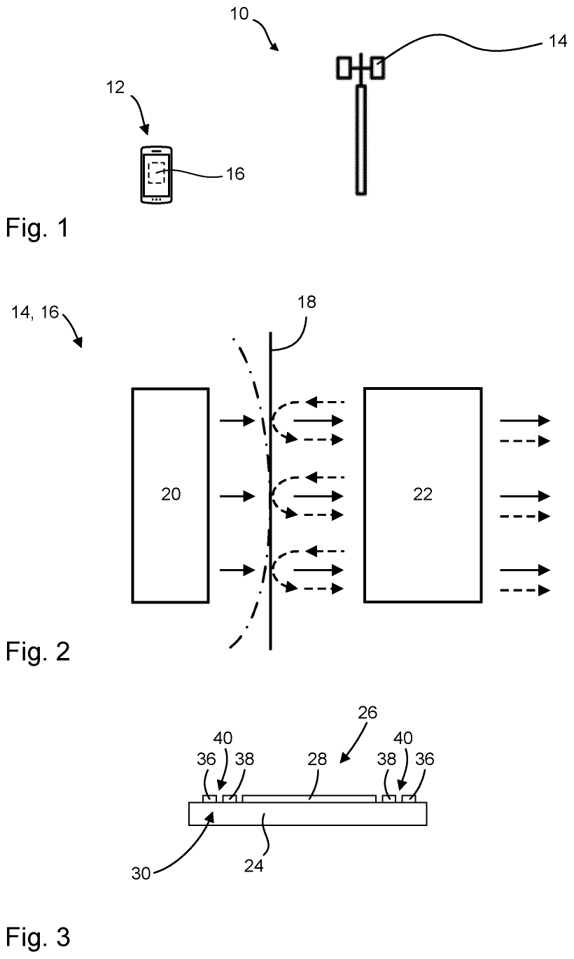

FIG. 1 shows an embodiment of a mobile communication base station 10 and an embodiment of a user device 12.

The mobile communication base station 10 has a plurality of antennas 14 for providing speech and data connections to user devices. Mobile communication base stations 10 are also referred to as mobile communication cell sites.

The mobile communication base station 10 may be an access network node of a radio access network of a telecommunication network, or any other similar 3^{rd} Generation Partnership Project (3GPP) access nodes or non-3GPP access points.

Moreover, as will be appreciated by those of skill in the art, an access a network node is not necessarily limited to an implementation in which a radio portion and a baseband portion are supplied and integrated by a single vendor. Thus, it will be understood that network nodes include disaggregated implementations or portions thereof.

For example, in some embodiments, the mobile communication base station 10 is an Open-RAN (ORAN) network node. An ORAN network node is a node in the telecommunication network that supports an ORAN specification (e.g., a specification published by the O-RAN Alliance, or any similar organization) and may operate alone or together with other nodes to implement one or more functionalities of any node in the telecommunication network, including one or more network nodes and/or core network nodes.

Examples of an ORAN network node includes an open radio unit (O-RU), an open distributed unit (O-DU), and an open central unit (O-CU).

The antenna 14 of the mobile communication base station 10 is a multiband antenna to provide speech and data connections in various frequency bands.

The user device 12 has an antenna 16 and may be a mobile phone, a laptop computer, or the like. The antenna 16 of the user device 12 is also a multiband antenna allowing a speech and/or data connection to the mobile communication base station 10 and/or to a communication satellite.

Both antennas 14, 16 have a frequency selective filter 18 as shown in FIG. 2.

FIG. 2 illustrates the working principle of the antennas 14, 16 schematically. The antennas 14, 16 are different in size, nevertheless, the working principle with respect to the frequency selective filter 18 remains the same.

The antennas 14, 16 have a single first radiator 20 or an array of first radiators 20 as well as a single second radiator 22 or an array of second the radiators 22, wherein between the one or more of the first radiators 20 and the one or more of the second radiators 22, the frequency selective filter 18 is arranged.

The one or more first radiators 20 and the one or more second radiators 22 may be dual polarized radiators. The one or more first radiators 20 are designed for receiving and transmitting electromagnetic waves in a first frequency band, and the one or more second radiators 22 are designed for receiving and transmitting electromagnetic waves in a second frequency band.

The second frequency band lies partly or fully below the first frequency band.

The first frequency band lies above 1.0 GHz, for example above 1.4 GHz, in particular fully. The first frequency band may be 3.3 GHz to 4.2 GHz.

The second frequency band lies below 1.5 GHZ, for example below 1 GHZ, in particular fully. The second frequency band may be 0.6 GHz to 0.96 GHz.

The frequency selective filter 18 is shown partially in an enlarged view in FIGS. 3, 4 and 5.

The frequency selective filter 18 comprises a substrate 24 and a conductive structure 26 provided at the substrate 24.

The conductive structure 26 is, for example, a metallization applied to the substrate 24.

In particular, the substrate 24 with the conductive structure 26 forms a printed circuit board (PCB).

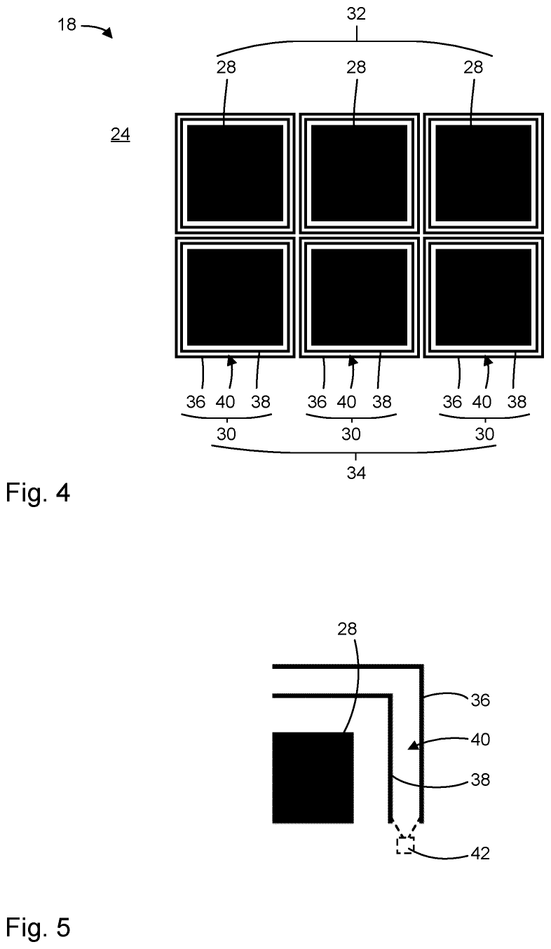

The substrate is shown in FIG. 3 only and has been omitted in FIGS. 4 to 12, in which black areas denote the presence of the conductive structure 26 on the substrate 24.

The conductive structure 26 comprises a plurality of filter elements 28 and a plurality of capacitive elements 30.

In the figures, only parts of the arrays formed by the filter elements 28 and the capacitive elements 30, respectively, are shown.

The substrate 24 is planar in the shown embodiment, and the conductive structure 26, i.e. the filter elements 28 and the capacitive elements 30, are arranged on a single surface, i.e. the same surface, of the substrate 24.

The filter elements 28 form an array of filter elements 28 that are arranged in the same plane. This plane is called “filter plane” within this disclosure. In particular, all filter elements 28 lie in the filter plane.

Within this disclosure, shapes and geometries are to be understood as seen in a top view onto the filter plane, e.g. as seen in FIG. 4.

It is also conceivable, that the substrate 24 is a multilayered substrate, e.g. a multilayered PCB. In this case, the conductive structure 26 is provided entirely in a single layer of the substrate 24, i.e. of the multilayered PCB.

It may also be the case that the substrate 24 is nonplanar. This case is illustrated with the dashed-dotted lines in FIG. 2. In this case, the terms “plane” or “filter plane” refer to the geometry in a state in which the substrate 24 is regarded spread out in a plane.

As best seen in FIG. 4, each of the filter elements 28 comprises a conductive portion, which is, in the shown embodiment, a squared patch, i.e. a portion of the conductive structure 26 having a squared outer contour and being solidly filled.

Due to the geometry of the filter elements 28, their spacing and arrangement, the filter elements 28, more precisely the array of filter elements 28 form a first resonance structure 32 for a particular frequency band. In the shown embodiment, this frequency band corresponds to the first frequency band of the first radiators 20. Thus, the frequency band of the first resonance structure 32 and the first frequency band of the first radiators 20 are identical, are contained in one another or overlap to at least 80%, particular at least 95%.

As such, the array of filter elements 28 form a frequency selective filter and the filter elements 28 may be regarded as a unit cell of this filter.

For example, one filter element 28 or one unit cell of the first resonance structure 32 has a size of about one half or one quarter of the wavelength of the average frequency of the first frequency band.

In the shown embodiment, the array of filter elements 28, thus the first resonance structure 32, is a band-pass or high-pass filter for electromagnetic waves in the first frequency band.

The capacitive elements 30 extend fully in the filter plane and form a second resonance structure 34.

The capacitive elements 30 each comprise a first conductive portion 36, a second conductive portion 38 and a gap 40, as best seen in FIG. 5.

The first conductive portion 36 and the second conductive portion 38 being part of the conductive structure 26, i.e. a metallization applied to the substrate 24.

The first conductive portion 36 and the second conductive portion 38 are galvanically separate from one another and spaced apart from one another by the gap 40.

The gap 40 may have a width of a most 0.2 mm, in particular of at most 0.05 mm.

For example, the electric width of the gap 40 may be at most 1/100, in particular 1/1500, more particularly at most 1/8000 of the wavelength of the average frequency of the second frequency band.

In the shown embodiment, the conductive portions 36, 38 and the gap 40 of each of the capacitive elements 30 form a closed trace around one of the filter elements 28. The associated filter element 28 is thus fully surrounded by the capacitive element 30 with respect to the filter plane.

For example, each of the capacitive elements 30 encircles one of the filter elements 28.

In the shown embodiment, a loop around the respective filter element 28 is provided.

The closed trace or loop is formed as the contour of the capacitive element 30, i.e. the contour of the conductive portions 36, 38 and the gap 40, follow the contour of the respective filter element 28, called first contour. Thus, the contours of the filter element 28 and of the capacitive element 30 are the same, except in size.

In the shown embodiment, the gap 40 follows the first contour of the filter elements 28 directly. It may however be, that the gap 40 follows the first contour in meanders, in waves or in any other arbitrary fashion.

Further, the geometric center of the filter element 28 and of the associated capacitive element 30 are the same.

As such, the capacitive elements 30 form the second resonance structure 34 in much the same way as the filter elements 28 form the first resonance structure 32.

Further, a capacitive coupling over a gap between conductive portions 36, 38 of neighboring capacitive elements 30 may be present and part of the second resonance structure 34.

The second resonance structure 34 is resonant in the second frequency band and forms, for example, a band-stop for electromagnetic waves in the second frequency band. The second resonance structure 34 is in particular transparent for electromagnetic waves in the first frequency band.

In the shown embodiment, the frequency band of the second resonance structure 34 corresponds to the second frequency band of the second radiators 22. Thus, the frequency band of the second resonance structure 34 and the second frequency band of the second radiators 22 are identical, are contained in one another or overlap to at least 80%, particular at least 95%.

Further, the second resonance structure 34 and the first resonance structures 32 have different filtering characteristics, i.e. high-pass, low-pass, band-pass, band-stop, etc. For example, the first resonance structure 32 is a high-pass filter, the second resonance structure 34 is a high-stop filter.

As shown in dashed lines in FIG. 5, the capacitive element 30 may further comprise a tuning device 42 which is galvanically connected to each of the first conductive portion 36 and the second conductive portion 38, i.e. bridging the gap 40. The tuning device 42 may be used to tune the resonance and shift the frequency band of the second resonance structure 34.

The tuning device 42 is, for example, a MEMS switch or a varactor.

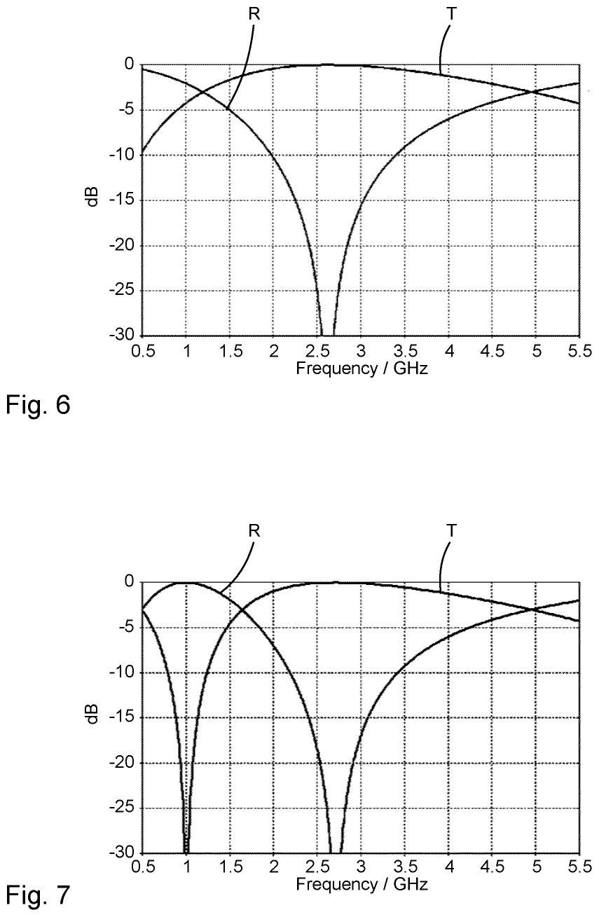

FIGS. 6 and 7 show the effect of the second resonance structure 34 by the capacitive elements 30 on the reflection and transmission characteristics of the entire frequency selective filter 18.

FIG. 6 shows a diagram showing the transmission T and the reflection R over frequency of the first resonance structure 32 only.

It can be seen that the first resonance structure 32 alone has a low reflectivity in the first frequency band (being, in the shown embodiment, at about 2.6 GHz) and a high transmissivity in the first frequency band. Thus, the first resonance structure 32 acts as a band-pass filter for electromagnetic waves in the first frequency band.

In the second frequency band, being at about 1 GHz, the transmission T is also high.

Turning now to FIG. 7, the transmission T and reflection R of a combined frequency selective filter 18 having the first resonance structure 32 and the second resonance structure 34 is shown. The transmission T and the reflection R in the first frequency band are almost identical to the case shown in FIG. 6. However, in the second frequency band, the second resonance structure 34 awakes a resonance leading to a band-stop, i.e. having a low transmissivity and a high reflectivity in the second frequency band.

The described frequency selective filter thus differs from other solutions, e.g. the one shown in US2019/0131713A, in that the second resonance structure is made of capacitive elements so that reflection of electromagnetic waves is achieved in the lower, second frequency band, whereas the frequency selective filter is transparent in the higher, first frequency band.

In this way, very efficient isolation between the one or more first radiators 20 and the one or more second radiators 22 is achieved. As depicted in FIG. 2, the electromagnetic waves emitted or intended for the one or more second radiators 22 are reflected by the frequency selective filter 18 due to the second resonance structure 34. These electromagnetic waves do therefore not interfere with the one or more second radiators 22.

At the same time, the electromagnetic waves emitted or intended for the one or more first radiators 20 in the first frequency band propagate through the frequency selective filter 18 with only little losses.

Thus, the frequency selective filter 18 provides a very compact but highly effective isolation of one or more radiators 20, 22 operating in different frequency bands. Thus, the signal quality of each of the radiators and thus of the antennas 14, 16 is improved without increasing complexity.

In a further embodiment, if more frequency bands have to be isolated from one another, it is conceivable that the substrate 24 comprises another conductive structure at a different layer or surface of the substrate 24 constituting a further frequency selective filter according to the invention.

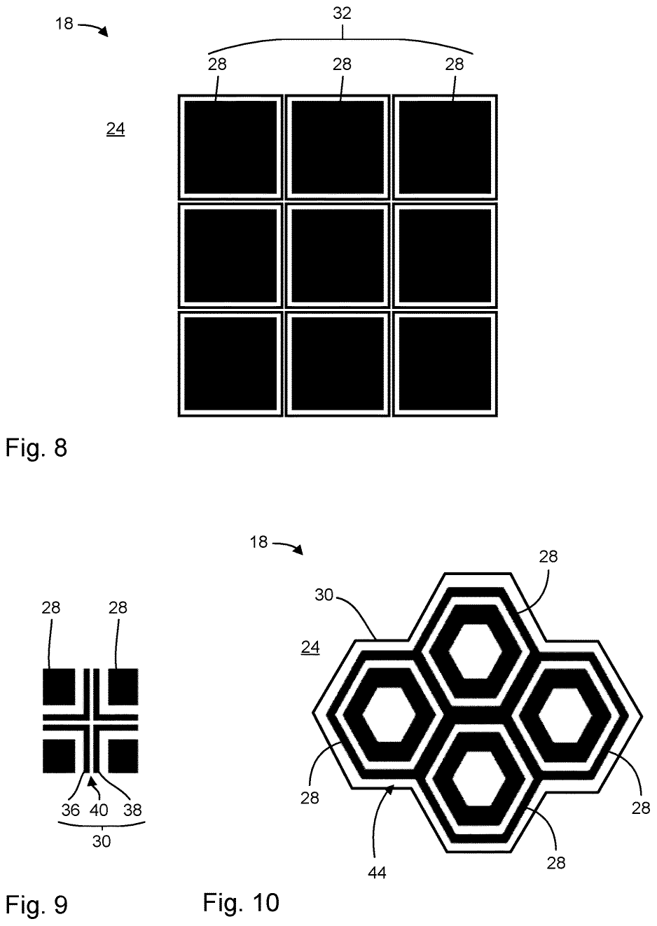

FIGS. 8 to 12 show further embodiments of the frequency selective filter 18 corresponding substantially to the first embodiment described above. Thus, in the following, only the differences are discussed and the same and functionally the same components are labelled with the same reference signs.

FIG. 8 shows a second embodiment of a frequency selective filter 18.

The first resonance structure 32, i.e. the filter elements 28, correspond to that of the first embodiment.

The capacitive elements 30, however, differ in the fact that adjacent capacitive elements 30 that encircle adjacent filter elements 28 have a common section.

In the shown embodiment, between adjacent filter elements 28 only one first conductive portion 36, one second conductive portion 38 and one gap 40 is provided. The one first conductive portion 36, the one second conductive portion 38 and the one gap 40 are common to the capacitive elements 30 encircling each of the adjacent filter elements 28.

With respect to FIG. 8, the capacitive element 30 encircling the bottom left hand filter element 28 has a common section with the capacitive element 30 encircling the filter element 28 on the left-hand side in the middle and with the capacitive element 30 encircling the filter element 28 on the bottom side in the middle.

To this end, as shown in the enlarged view of FIG. 9, the gaps 40 may also have common sections.

The gaps 40 form lines throughout the array, both vertically and horizontally. The gaps 40 intersect at the edges of the capacitive elements 30 and form a grating.

Optionally, a tuning device 42 may be connected between first and second conductive portions 36, 38 for tuning the resonance of the second resonance structure 34.

FIG. 10 shows a third embodiment of a frequency selective filter 18.

In this embodiment, the filter elements 28 have a geometry of a hexagonal loop surrounding a smaller hexagonal loop.

Four adjacent filter elements 28 form a group 44 of filter elements constituting a unit cell of the first resonance structure 32. The four filter elements 28 are in particular in contact with one another.

The group 44 of filter elements 28 has an outer contour, being the first contour in this embodiment.

Each capacitive element 30 in this third embodiment does not encircle only a single filter element 28 but a single group 44 of filter elements 28. As discussed with respect to the first embodiment, the capacitive element 30 follows the first contour of the group 44 of filter elements 28.

In FIG. 10, the capacitive element 30 is shown only as a single line for the ease of illustration. Of course, the capacitive element 30 comprises the first and second conductive portions 36, 38 forming the gap 40 in between.

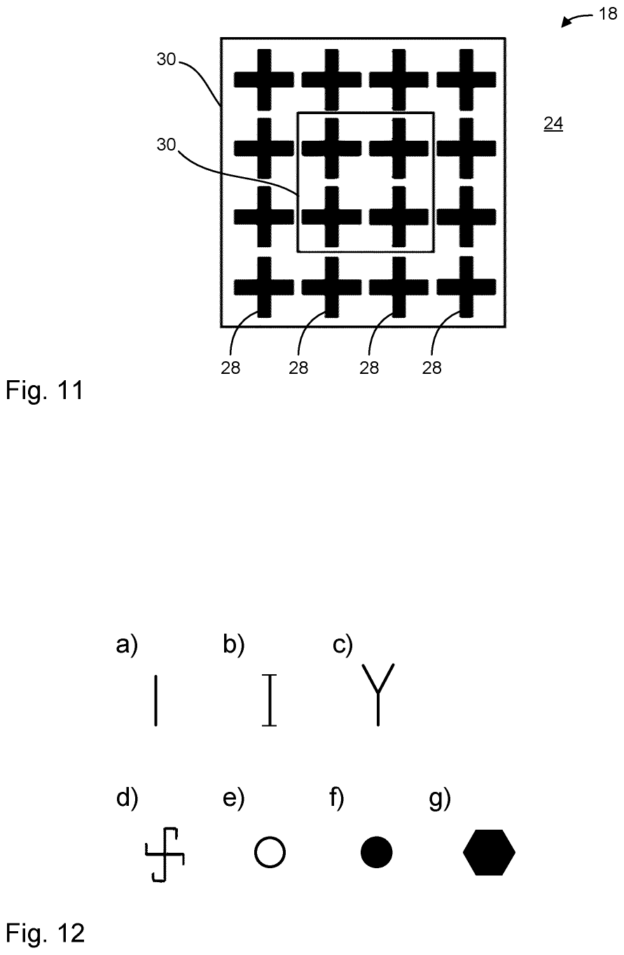

FIG. 11 shows a fourth embodiment of the frequency selective filter 18, wherein the filter elements 28 comprise conductive portions having a geometry being a cross.

The filter elements 28 are arranged in a regular grid and the capacitive elements 30 have a squared contour.

In this fourth embodiment, a first type of the capacitive elements 30 encircles a group of sixteen filter elements 28.

A second type of capacitive element 30 encircles a subgroup of the group of sixteen filter elements 28, namely the four filter elements 28 in the center of the group of sixteen filter elements.

Thus, the first type of capacitive element 30 also encircles the second type of capacitive element 30. The first type of capacitive element 30 may be regarded as the encircling capacitive element 30 and the second type of capacitive element 30 may be regarded as the encircled capacitive element.

Further, the first and second type of capacitive elements 30 have a geometry being concentric to one another.

Put in a different way, the first type of capacitive element 30 encloses the group of sixteen filter elements 28 arranged in a 4×4 grid, wherein the group of 2×2 filter elements 28 at the center are encircled by the second type of capacitive element 30.

The use of two types of capacitive elements 30 leads to a broader second frequency band.

In FIG. 12a) to g), different geometries of a single one of the filter elements 28 are shown. The geometry of the filter element 28 is a line in FIG. 12a), is a dipole in FIG. 12b), is a tripole in FIG. 12c), is a squared spiral in FIG. 12d), is a circular loop in FIG. 12e), is a circular patch in FIG. 12f), and is a hexagonal patch in FIG. 12g).

These geometries and/or complements thereof may be used, also in combination, as geometries for the filter elements 28 in any of the embodiments described above.

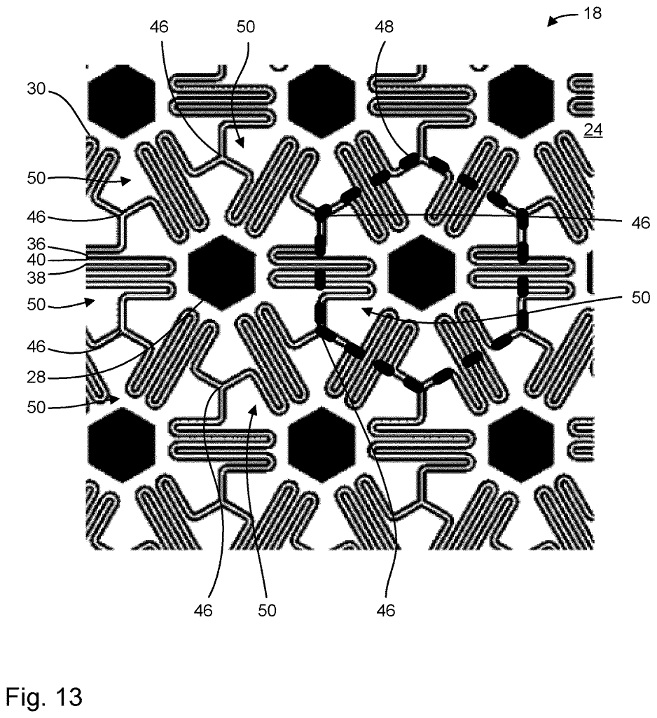

FIG. 13 shows a fifth embodiment of a frequency selective filter 18, corresponding substantially to the second embodiment shown in FIG. 8.

As discussed with respect to the second embodiment, adjacent capacitive elements 30 that encircle adjacent filter elements 28 have a common section and the gaps 40 intersect.

Intersections 46 of the gaps 40 form a point or regions where three or more unit cells 48 and/or filter elements border each other.

In the fifth embodiment, the filter elements 28 are formed as hexagonal patches and each unit cell 48 comprises one filter element 28, leading to hexagonal unit cells 48 (one of the unit cells 48 is highlighted with a dashed line in FIG. 13).

With respect to one unit cell 48 and/or one filter element 28, the respective capacitive element 30 forming a closed trace around the one unit cell 48 and/or one filter element 28 passes six intersections 46. More precisely, the respective gap 40 of the capacitive element 30 is part of six intersections 46.

In the fifth embodiment, as an example only, the capacitive element 30 extends partly in meanders, i.e. the capacitive element 30 has a meander section 50. The first conductive portion 36, the second conductive portion 38 and the gap 40 also have the meander section 50.

In the fifth embodiment, a meander section 50 is provided between each pair of neighboring intersections 46, i.e. each capacitive element 30 forming a closed trace around the one unit cell 48 and/or one filter element 28 comprises six meander sections 50.

Within each of the meander sections 50 the first conductive portion 36, the second conductive portion 38 and the gap 40 extend in at least one meander. In the shown example they extend in four meanders in each of the meander sections 50.

By providing the meander sections 50, the resonance stability of the second resonance structure 34 (i.e. in the second frequency band) is improved. Further, the size of the unit cells 48 may be reduced.

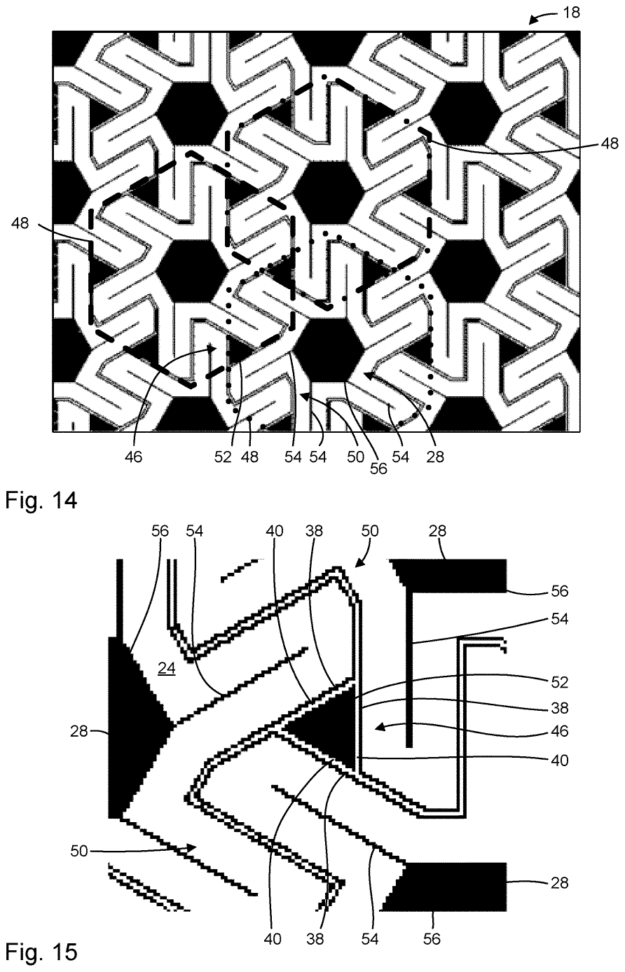

FIG. 14 shows a sixth embodiment of the frequency selective filter 18 corresponding substantially to the fifth embodiment.

Similar to the fifth embodiment, the sixth embodiment comprises hexagonal filter elements 28 and/or unit cells 48, and the capacitive elements 30 have meander sections 50.

In difference to the fifth embodiment, adjacent unit cells 48 overlap, as illustrated with dotted, dashed and dotted-dashed lines in FIG. 14. This way, the unit cells 48 may be packed closer together.

The intersections 46 of the gaps 40 are not points, as in the fifth embodiment, but intersection regions. In particular, at the intersections 46 three unit cells 48 overlap.

FIG. 15 shows an enlarged view of an intersection 46 of the sixth embodiment. At the intersection 46, the conductive portions 38 of the capacitive elements 30 form a triangle, wherein a supplementary conductive portion 52 is provided in the triangle.

The supplementary conductive portion 52 is spaced apart from each of the conductive portions 38 so that the gap 40 is formed between conductive portion 38 and the supplementary conductive portions 52 in the intersection regions.

Further, in the sixth embodiment, the filter elements 28 comprise a plurality of protrusions 54 extending from the hexagonal main body 56 of the filter elements 28 outwards.

Each of the protrusions 54 extends in a meander formed by the capacitive elements 30, e.g. in an area defined on three sides by the conductive portion 38 adjacent to the respective filter element 28.

By virtue of the protrusions 54, a constant coupling of the capacitive element 30 to the adjacent filter element 28 is provided, improving the filter quality.

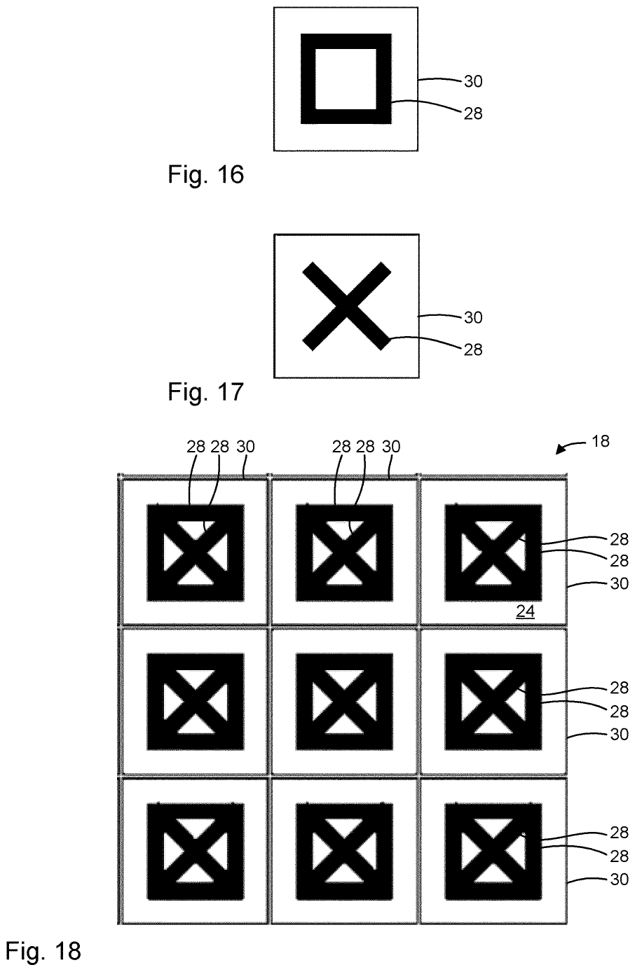

FIGS. 16, 17 and 18 shows a seventh embodiment of the frequency selective filter 18. In this seventh embodiment, the conductive structure 26 is provided on two surfaces or layers of the substrate 24, namely a first surface or layer and a second surface or layer.

For example, the first surface is the front surface and the second surface is the back surface of the substrate 24. In particular, in case of a multilayer substrate, the first and second layer are adjacent layers.

FIG. 16 shows a top view onto the first surface or first layer of the substrate 24. On the first surface or layer, the conductive structure 26 comprises a first array of filter elements 28 and corresponding first capacitive elements 30. The filter elements 28 of the first array and the corresponding first capacitive elements 30 are therefore in a first filter plane.

FIG. 16 shows only a single filter element 28 but the arrangement of the conductive structure 26 on the first surface or layer is similar to that shown in FIG. 8, in particular that the first capacitive elements 30 encircling adjacent filter elements 28 have a common section.

In difference to FIG. 8, in the seventh embodiment the filter elements 28 of the first array of filter elements 28 are in form of a loop, in particular a square loop.

FIG. 17 shows a top view onto the second surface or second layer of the substrate 24. Similar to the situation on the first surface or layer, the conductive structure 26 comprises a second array of filter elements 28 and corresponding second capacitive elements 30. The filter elements 28 of the second array and the second corresponding capacitive elements 30 are therefore in a second filter plane.

FIG. 17 shows only a single filter element 28 of the second array but the arrangement of the conductive structure 26 on the second surface or layer is very similar to that of the first surface or layer, in particular that the second capacitive elements 30 encircling adjacent filter elements 28 have a common section.

In difference to the first surface or layer, the filter elements 28 of the second array of filter elements 28 are in form of crosses.

The first and second capacitive elements 30 on the first and second surface or layer, respectively, are arranged directly opposite to one another so that for each first capacitive element 30 on the first surface or layer a second capacitive element 30 on the second surface or layer is present at the same position.

Similarly, the filter elements 28 of the first array and of the second array are located directly opposite to one another so that for each filter element 28 of the first array on the first surface or layer a filter element 28 of the second array on the second surface or layer is provided at the same position. In particular, the geometric centers of the filter elements 28 on the two surfaces or layers coincide.

This arrangement is illustrated in FIG. 18 showing the conductive structure 26 of the first and second surface or layer in a projection perpendicular to the surfaces or layers. As can be seen, the first and second capacitive elements 30 are identical and overlap of 100 % of their area.

Further, the filter elements 28 of the first and second array are at the same location, in particular their geometric centers coincide. In the shown embodiment, there is also an overlap of the filter elements 28 of the first and second array.

By virtue of having two arrays of filter elements 28, the bandwidth of the resonance of the first resonance structure is widened.

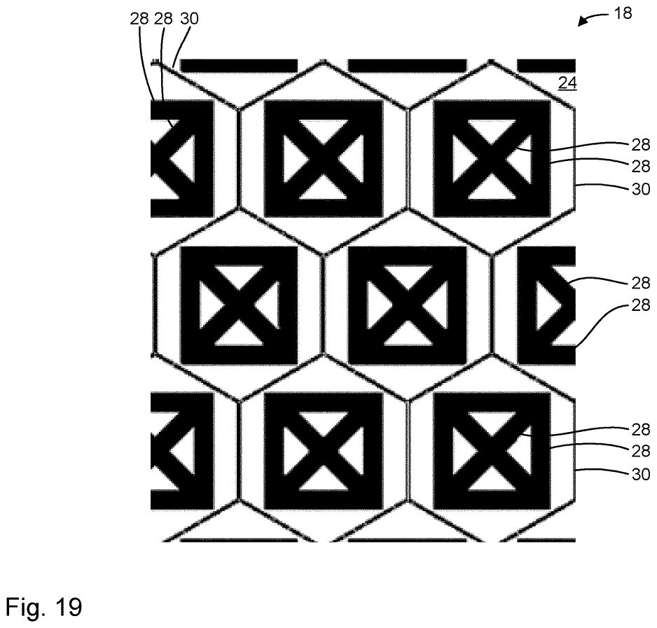

FIG. 19 shows, in a projection perpendicular to the substrate 24, an eighth embodiment substantially corresponding to the seventh embodiment.

The filter elements 28 of the first and second arrays of filter elements 28 are the same as in the seventh embodiment. The eighth embodiment differs in the form of the first and second capacitive elements 30.

In the eighth embodiment, the first and second capacitive elements 30 extend in hexagons, allowing the unit cells to be hexagonal as well. This way, the filter elements 28 may be positioned closer together.

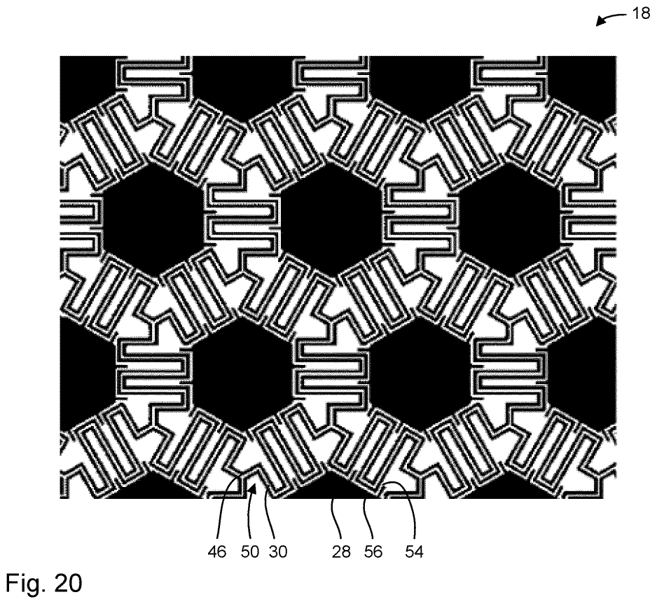

FIG. 20 shows, in a projection perpendicular to the substrate 24, a ninth embodiment substantially corresponding to the sixth embodiment (FIG. 14).

Also in the ninth embodiment, the filter elements 28 are hexagonal and the unit cells 48 overlap. The capacitive elements 30 have meander sections 50 and intersect at intersections 46.

In contrast to the sixth embodiment, in this ninth embodiment, the intersections 46 are points. Thus, no supplementary conductive portions 52 are necessary.

Within each meander section 50 and thus between adjacent intersections 46, four meanders are provided in the ninth embodiment.

Further, in the ninth embodiment, the filter elements 28 comprise a plurality of protrusions 54 (in the shown example twelve protrusions per filter element 28) extending from the hexagonal main body 56 of the filter elements 28 outwards. The protrusions 54 of the ninth embodiment are, however, shorter than the ones of the sixth embodiment.

Further, the features of the embodiments described above may be combined freely with one another. In particular, the geometries of the filter elements 28 may be different.

1-26. (canceled)

27. A frequency selective filter for electromagnetic waves comprising a substrate and a conductive structure provided on the substrate, the conductive structure comprising a plurality of filter elements and a plurality of capacitive elements,
wherein the plurality of filter elements forms an array of filter elements forming a first resonance structure for a first frequency band,
wherein the capacitive elements of the plurality of capacitive elements encircle one of or a group of the plurality of filter elements comprised in the array of filter elements, wherein the plurality of capacitive elements forms a second resonance structure for a second frequency band,
wherein the array of filter elements spans a filter plane, at least one capacitive element extending in the filter plane, and
wherein the second resonance structure for the second frequency band has a different filtering characteristic as the first resonance structure.

28. The frequency selective filter of claim 27, wherein the first resonance structure for the first frequency band is a band-stop, band-pass or high-pass filter for electromagnetic waves in the first frequency band.

29. The frequency selective filter of claim 27, wherein the first frequency band lies above 1.0 GHz, and/or wherein the second frequency band lies below 1.5 GHZ.

30. The frequency selective filter of claim 27, wherein each of the filter elements comprise at least one conductive portion applied to the substrate; a dipole; a tripole; a cross; a square spiral; a loop; a patch; a combination thereof and/or a complement thereof.

31. The frequency selective filter of claim 27, wherein the at least one capacitive element comprises a first conductive portion and a second conductive portion spaced apart from the first conductive portion by a gap that galvanically separates the first and second conductive portions.

32. The frequency selective filter of claim 31, wherein the at least one capacitive element comprises a tuning device galvanically connected between the first conductive portion and the second conductive portion.

33. The frequency selective filter of claim 31, wherein the gap has a width being at most 0.2 mm and/or an electric width being at most 1/100.

34. The frequency selective filter of claim 31, wherein the first conductive portion, the second conductive portion and the gap have a meander section in which the first conductive portion, the second conductive portion and the gap extend in at least one meander.

35. The frequency selective filter of claim 27, wherein one of the plurality of filter elements or one of the groups of the plurality of filter elements comprises a protrusion extending into an area defined by the adjacent first or second conductive portion, by one of the at least one meander of the meander section.

36. The frequency selective filter of claim 27, wherein the at least one capacitive element forms a closed trace around the one of or the group of the plurality of filter elements.

37. The frequency selective filter of claim 27, wherein the one filter element and/or the group of the plurality of filter elements has a first contour, wherein the at least one capacitive element extends along the first contour.

38. The frequency selective filter of claim 27, wherein the entire conductive structure is provided on a single surface or a single layer of the substrate.

39. The frequency selective filter of claim 27, wherein the conductive structure comprises a first array of filter elements and a second array of filter elements as well as first capacitive elements of the plurality of capacitive elements encircling one of or a group of the plurality of filter elements comprised in the first array of filter elements and second capacitive elements of the plurality of capacitive elements encircling one of or a group of the plurality of filter elements comprised in the second array of filter elements,
wherein the first array of filter elements and the first capacitive elements are located in a first filter plane on a first surface or layer of the substrate, and the second array of filter elements and the second capacitive elements are located in a second filter plane and on a second surface or layer of the substrate.

40. The frequency selective filter of claim 39, wherein, in a projection perpendicular to the substrate, the geometric centers of the filter elements of the first array of filter elements correspond to the geometric centers of the filter elements of the second array of filter elements.

41. The frequency selective filter of claim 39, wherein the geometry of the filter elements of the first array of filter elements differs from the geometry of the filter elements of the second array of filter elements.

42. The frequency selective filter of claim 39, wherein, in a projection perpendicular to the substrate, the first capacitive elements and the second capacitive elements have an overlap of at least 80% of their area.

43. The frequency selective filter of claim 27, wherein the second resonance structure for the second frequency band forms a band-stop for electromagnetic waves in the second frequency band.

44. The frequency selective filter of claim 27, wherein the plurality of capacitive elements encircling adjacent ones or adjacent groups of the plurality of filter elements have a common section.

45. The frequency selective filter of claim wherein the at least one capacitive element comprises a first conductive portion and a second conductive portion spaced apart from the first conductive portion by a gap that galvanically separates the first and second conductive portions, and wherein the common section is a shared portion of the gap of the plurality of capacitive elements and/or that the gaps of the plurality of the capacitive elements form a grating.

46. The frequency selective filter of claim 43, wherein the at least one of the plurality of capacitive elements encircles a group of the plurality of filter elements and also encircles another capacitive element encircling one or a subgroup of the group of the plurality of filter elements.

47. The frequency selective filter of claim 27, wherein the second frequency band lies at least partly below the first frequency band.

48. The frequency selective filter of claim 27, wherein the substrate is non-planar, wherein the filter plane refers to a state in which the substrate is spread out in a plane.

49. An antenna having a frequency selective filter according to claim 27.

50. The antenna of claim 49, wherein the antenna has a first radiator or an array of first radiators designed for a first frequency band and a second radiator or an array of second radiators designed for a second frequency band, wherein the frequency selective filter is arranged between the first radiator or the array of first radiators and the second radiator or the array of second radiators, wherein the array of filter elements is transmissive for electromagnetic waves in the first frequency band and the at least one capacitive element is reflective for electromagnetic waves in the second frequency band.
